(19) United States
(12) Patent Application Publication
(10) Pub. No.: US 2015/0088642 A1
(43) Pub. Date: Mar. 26, 2015

(54) INTELLIGENT SHOPPING CART SERVICE

(71) Applicant: MasterCard International Incorporated, Purchase, NY (US)

(72) Inventor: Bejoy Mathew, Dardenne Prairie, MO (US)

(73) Assignee: MasterCard International Incorporated, Purchase, NY (US)

(21) Appl. No.: 14/037,636

(22) Filed: Sep. 26, 2013

(51) Int. Cl. G06Q 30/06

(52) U.S. Cl. CPC G06Q 30/0633; G06Q 30/0631
USPC 705/14.51; 705/26.8; 705/26.7

(57) ABSTRACT

Disclosed are methods, apparatus and systems for providing an intelligent shopping cart service that operates to alert a consumer when a product or service is not aligned with the consumer's preferences, criteria or requirements before a purchase transaction is consummated. In some embodiments, a consumer device includes a processor that stores intelligent shopping cart software in a memory, and that uses the intelligent shopping cart software to detect product or service identification data when a consumer adds a product or service to a shopping cart. The processor then determines, based on the product or service identification data, that the product or service is a mismatch when compared to predetermined consumer preferences, criteria or requirements. An alert indication is then provided to the consumer via an output component before a purchase transaction is consummated.

### FIELD OF THE INVENTION

Embodiments disclosed herein generally relate to methods, apparatus and systems for providing an intelligent shopping cart service. In an embodiment, the intelligent shopping cart service operates to alert a consumer when a product or service is not aligned with the consumer's preferences, criteria or requirements before a purchase transaction is consummated.

### BACKGROUND

The Internet has changed the way in which consumers shop and purchase products and services. In particular, consumers desire easy access to product and/or service information, to pricing information, to merchants' offerings, and to convenient and secure methods of payment for goods and services. It is common for consumers to own one or more electronic devices that are configured for connection to the Internet via, for example, cable-type modems or DSL-modems and/or routers, which may provide wired or wireless Internet access. For example, consumers may own laptop computers, tablet computers, Smartphones, personal digital assistants (PDAs) and/or desktop computers that can connect to the Internet. Such Internet-connected devices may be configured for receiving content to display to consumers, and/or configured to obtain information and/or instructions and/or purchase transaction data from consumers, and/or configured to transmit information and/or purchase transaction data or instructions to third parties, such as merchants.

It is known that a consumer's shopping habits are often highly aligned or correlated with that consumer's preferences and/or any unique products or services constraints. For example, a particular consumer may have one or more special dietary preferences and/or requirements with regard to food products that will be purchased for their family members, such as a preference or requirement for foods that are Organic, Cholesterol Free, Gluten Free, Dairy Free, Fat Free, Low Fat, Lower Sugar, High Fiber, Whole Grain, No Sodium, Low Sodium, Wheat Free, Kosher, Vegetarian Vegan, and the like. Such consumers may be spending hours of their shopping time making sure that the food supplies they purchase online or at a retail store, such as at a green grocer or supermarket, meets their criteria. Consumers may also have preferences or requirements for purchasing certain technology products, travel packages, entertainment items, personal care products, toiletries, financial services and/or beverages. Some of these preferences or requirements may be based on beliefs or concerns, such as that products should be environmentally friendly, and/or should be of a particular brand name, and/or should be budget-priced or “on sale”. A consumer may also have medical or dietary reasons for purchasing certain products and/or services. However, due to the vast amount of products and services for sale online and at merchant retail locations, it can be very difficult for consumers to ensure that the products and/or services they select match all of their own criteria in a quick and easy manner. Thus, in some cases, consumers mistakenly purchase products and/or services online and/or at merchant retail locations that ultimately must be returned because these products and/or services do not match the consumers' expectations, preferences, criteria and/or requirements. Returning such mismatched products and/or services wastes time and money for both consumers and merchants.

Thus, a need exists for systems and/or methods to simplify and/or facilitate the online and/or retail store shopping experiences so that consumers can be quickly and efficiently alerted or advised when a particular product or item or service does not meet their preferences, criteria and/or their requirements before a purchase transaction is consummated.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, which illustrate exemplary embodiments and which are not necessarily drawn to scale, wherein:

FIG. 1 is a block diagram illustrating an intelligent shopping cart system according to an embodiment of the invention;

FIG. 2 is a flowchart illustrating a cardholder intelligent shopping cart registration process according to an embodiment of the invention;

FIG. 3 is a flowchart illustrating an online intelligent shopping cart process according to an embodiment of the invention;

FIG. 4 is a flowchart illustrating a consumer mobile device intelligent shopping cart process according to an embodiment of the invention;

FIG. 5 is a flowchart illustrating a merchant device intelligent shopping cart process according to an embodiment of the invention; and

FIG. 6 is a block diagram illustrating a merchant device configured to provide intelligent shopping cart service functionality according to an embodiment of the invention.

### DETAILED DESCRIPTION

In general, and for the purpose of introducing concepts of embodiments, described are systems and/or methods for providing an intelligent shopping cart service for consumers. In some embodiments, a consumer enrolls or registers for the intelligent shopping cart service by using a consumer device running browser software to visit a smart preferences website and to provide information, or provides information in some other manner to the system. The information may include consumer identification data and preferences, criteria and/or requirements data regarding products and services. In some implementations, intelligent shopping cart application programming interface (API) software is downloaded and stored on the consumer's device. The intelligent shopping cart API software is operable to recognize product identifiers and then, based on the preferences, criteria and/or requirements data provided by the consumer during enrollment, determine whether or not a particular item or service matches the consumer preferences and/or requirements before a purchase transaction is consummated. If there is a product mismatch, then an alert notification or indication is provided to the consumer so that the consumer has the opportunity to select a replacement product.

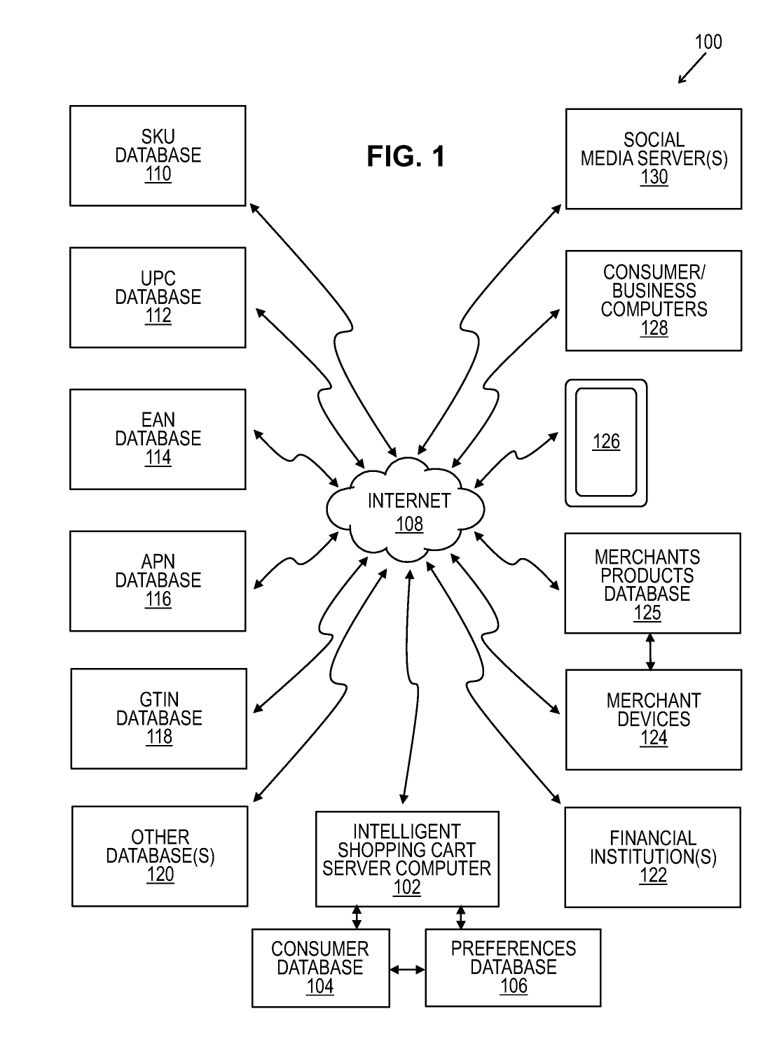

FIG. 1 is a block diagram illustrating an intelligent shopping cart system 100 according to an embodiment. The intelligent shopping cart system 100 includes components configured to operate in accordance with aspects of the processes described herein. It should be understood that the various components shown in FIG. 1 may be a subset of a larger system that could be used to, for example, register or enroll consumers and/or to alert and/or advise consumers regarding their products or services choices with regard to their predefined preferences, criteria and/or requirements before a purchase transaction is consummated. It should also be understood that, in some embodiments, consumers, merchants, issuer financial institutions (FIs) and/or acquirer FIs may participate in the consumer enrollment or registration process (for example, via an intelligent shopping cart website or webpage hosted by a an intelligent shopping cart server computer system) before intelligent shopping cart processing in accordance with embodiments described herein can occur.

Referring to FIG. 1, an intelligent shopping cart server computer 102 is operably connected to a consumer database 104 and a preferences database 104, which database may also be operably connected to each other. Although shown separately, the consumer database 104 and preferences database 106 may be part of, or a portion of, a single database. In this example, the intelligent shopping cart server computer 102 is operably connected to the Internet 108, and may be configured for communications with one or more product or item or service identification databases, such as a Stock Keeping Unit (SKU) database 110, a Universal Product Code (UPC) database 112, an International Article Number (EAN) database 114, an Australian Product Number (APN) database 116, a Global Trade Item Number (GTIN) database 118, a merchant products database 125, and one or more other databases 120. The product identification databases 110 to 118 may be maintained and/or updated by third party providers and typically include data attributes for products that may include, but are not necessarily limited to, manufacturer name, product or service descriptions including product ingredients (if applicable), material, size, color, packaging, and/or warranty terms. In addition, some of the identifiers may not be associated with physical items or objects, but may instead concern services or items or things such as extended warranties, delivery fees, installation fees, licenses and the like. The merchant products database 125 may be maintained and/or updated by each merchant participating in the intelligent shopping cart service. In addition, in some implementations one of the other databases 120 may include a “retail store map” database that contains merchant retail store information such as store address data, hours of operation data, store layout data (such as a map of each selling floor), retail store product location data, and the like. Each merchant participating in the intelligent shopping cart service may be responsible for maintaining and/or updating the data in their own corresponding retail store map database.

The intelligent shopping cart system 100 may also include one or more financial institutions 122, which may include third party entities, such as payment card account issuer banks and/or merchant acquirer banks. The system 100 may also include a plurality of merchant devices 124 (such as web servers, custom in-store devices, point-of sale (POS) terminals, and the like), consumer mobile devices 126 (such as Smartphones, tablet computers, laptop computers, personal digital assistants (PDAs), or other types of mobile devices capable of receiving and transmitting data as described herein), consumer and/or business desktop computers 128, and one or more social media server computers 130 (which may be associated with social media services or companies such as Facebook®, Twitter®, Google Plus®, Groupon® and the like). In some embodiments, the consumer's mobile device 126 may be a payment-enabled mobile telephone or Smartphone, and the merchant devices 124 may be custom-made tablet computers that are physically attached to shopping carts available at a merchant's retail location and that include, for example, a reader device and a touch screen. In some embodiments, the merchant device 124 includes one or more merchant server computers that are utilized for hosting one or more online shopping websites. In some implementations, the merchant device 124 may be configured for communications with a merchant products database 125, which may store a list of available products along with product characteristics and/or attributes and/or information and the like. Product characteristics and/or attributes may include aspects such as price, unit price, weight, shape, size, ingredients, and the like. Each merchant enrolled in the intelligent shopping cart system may be required to maintain and/or update their own merchant product database. It should be understood that the various components shown in the intelligent shopping cart system 100 of FIG. 1 may be configured for wireless communications through the Internet 108 (as shown) with each other to access and/or process data as described herein, or may be configured for connection through one or more computer networks, including one or more secure computer networks and/or communication links (if required and/or desired).

As mentioned above, the consumer's mobile device 126 may be a mobile telephone or Smartphone. In some embodiments, such a consumer mobile device 126 is payment-enabled, which means that it is capable of initiating payment transactions in a payment card system. However, it should be understood that the consumer's mobile device 126 need not be payment-enabled to perform the novel intelligent shopping cart functions described herein.

It should be understood that a consumer may enroll or register with the intelligent shopping cart server computer 102 in any of a number of ways, including utilizing a mobile device to access a intelligent shopping cart server computer 102 via the Internet and providing required information. During customer registration, a consumer may provide basic information about himself or herself and, in some embodiments, provide information regarding the customer's mobile devices (for example, by providing a SIM identifier and/or a mobile telephone number and/or other device identifier). The consumer may also provide information concerning one or more bank credit card accounts, debit card accounts, loyalty card accounts, and/or gift cards issued to or held by him or her. In addition, the consumer may provide information and/or preferences concerning one or more family members, such as a spouse and/or children to form a “Household” intelligent shopping cart service account. Furthermore, in practice the intelligent shopping cart system 100 may include numerous other types of databases, many financial institution computers 122, a large number of merchant devices 124 and social media servers 130, and a large number of customer mobile devices 126 and consumer and/or business computers 128. Moreover, instead of the Internet 108, various components may be configured to communicate with each other via conventional computer-to-computer data networks, and/or over secure network connections, and such data communications may be in digital form and/or in analog form.

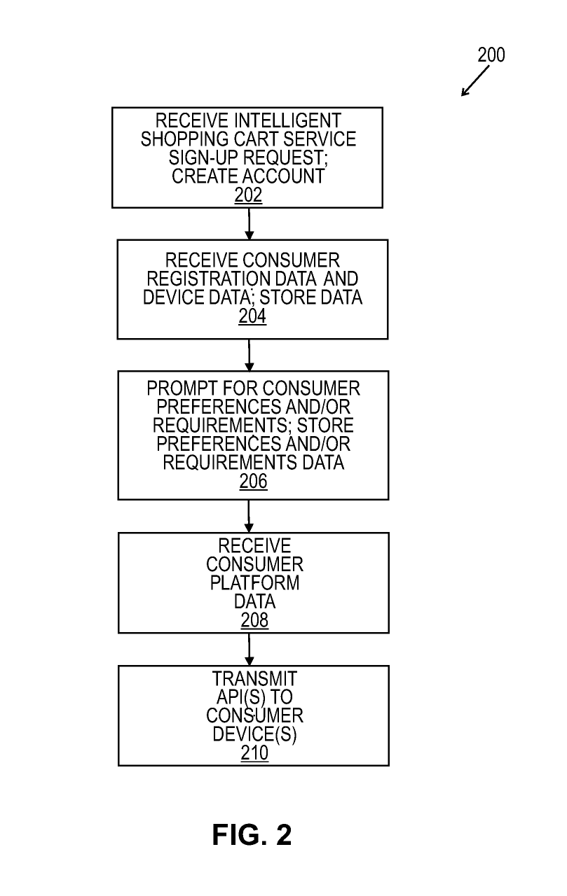

FIG. 2 is a flowchart illustrating a cardholder intelligent shopping cart registration process 200 according to an embodiment. In some embodiments, an intelligent shopping cart server computer 102 (See FIG. 1) hosts a webpage (not shown) for receiving input from consumers and receives 202 a sign-up request from a consumer to create an account. The account may be created by the intelligent shopping cart server computer 102 in a conventional manner, by requiring, for example, the consumer to select a username, password and security question and response combination. Once the account is created, the consumer is prompted to provide consumer registration information, which registration data is received 204 and then stored in the consumer database 104. The consumer registration data may include information such as the consumer's name, residence address, primary account number (PAN) of a credit or debit payment card account, and an expiration date of one or more payment card accounts. In practice, the registration data required from a consumer and any optional data that can be provided by a consumer may be determined by the entity operating the intelligent shopping cart server computer 102.

Referring to FIG. 2, the intelligent shopping cart server computer 102 prompts 206 the consumer to provide consumer preferences and/or requirements data. For example, the consumer may be provided with a menu or a list of products and/or services categories that can be selected, such as Apparel, Household products, Food products, Beverages, Electronic products, Jewelry, Paper products, Personal Care products and General Merchandise. After a category is chosen, one or more sub-categories associated with the chosen category may be displayed for selection. After choosing a sub-category, the consumer may then be provided with a preferences menu, which may be used to select preferences, criteria and/or requirements. The various choices may be provided, for example, through presentation of multiple drop-down menus (not shown) and the like, but other known types of data gathering processes may be utilized. For example, a consumer may have preferences including that all food products must be Gluten-free, jewelry must be hypo-allergenic, a preference for gold jewelry, and/or a product preference of “Made in the U.S.A.” These preferences, criteria and/or requirements may be identified and/or defined by the consumer and then stored in the preferences database 106. After enrollment, the consumer may use his or her username and password to access an intelligent shopping cart update webpage to update and/or change any preferences, criteria or requirements data when, for example, the consumer wishes to keep up with fashion trends or the like.

Referring again to FIG. 2, the intelligent shopping cart server computer 102 next receives 208 consumer platform data which identifies the consumer's electronic devices. For example, the consumer may only have a personal desktop computer, or may have other or additional devices such as a mobile telephone or tablet computer capable of running intelligent shopping cart software. Such intelligent shopping cart software may be provided to each of the consumer's electronic devices, for example, a plug-in application may be provided for the consumer's browser software, or application programming interface (API) software may be generated for each of the consumer's electronic devices. Thus, in response to requests from a consumer, the intelligent shopping cart server computer 102 transmits 210 the API(s) to the consumer's electronic device(s). For example, the intelligent shopping cart server computer 102 may download an API to the consumer's Smartphone, where it is stored. The intelligent shopping cart Smartphone API may be configured to detect when the consumer is shopping at a merchant retail location, and to permit the consumer to utilize the Smartphone's camera to scan product identifiers (such as SKU barcodes) of each product being considered for purchase while shopping. Processing then may occur in the Smartphone itself, or the Smartphone may transmit product identification data to the intelligent shopping cart server computer to process the product identifier data (which will be explained in more detail below).

In some embodiments, after a consumer has registered for the intelligent shopping cart service, she may then utilize one of her electronic devices, such as a tablet computer, to log-in to her intelligent shopping cart account prior to or during a shopping experience. If that device does not yet contain intelligent shopping cart software, the consumer can transmit a software request to download the intelligent shopping cart software from the intelligent shopping cart server computer 102. The software would then be downloaded to and stored on the consumer's device, where it is then ready for immediate use.

In addition, in some embodiments, a consumer registered with the intelligent shopping cart service may login to the intelligent shopping car server computer and create or build an intelligent shopping cart list (a shopping list) of items that he or she desires to purchase. The intelligent shopping cart list may be created by the consumer at home for use in shopping at a particular retail store, or may be created for use to shop online. In some embodiments, the intelligent shopping cart list can be downloaded to the consumer's mobile device, and/or may be printed out by the consumer. In addition, while compiling the list, the intelligent shopping cart server computer may include processor executable code configured for providing suggestions regarding merchant(s) who offer for sale one or more of the items on the intelligent shopping cart list that are desired for purchase by the consumer.

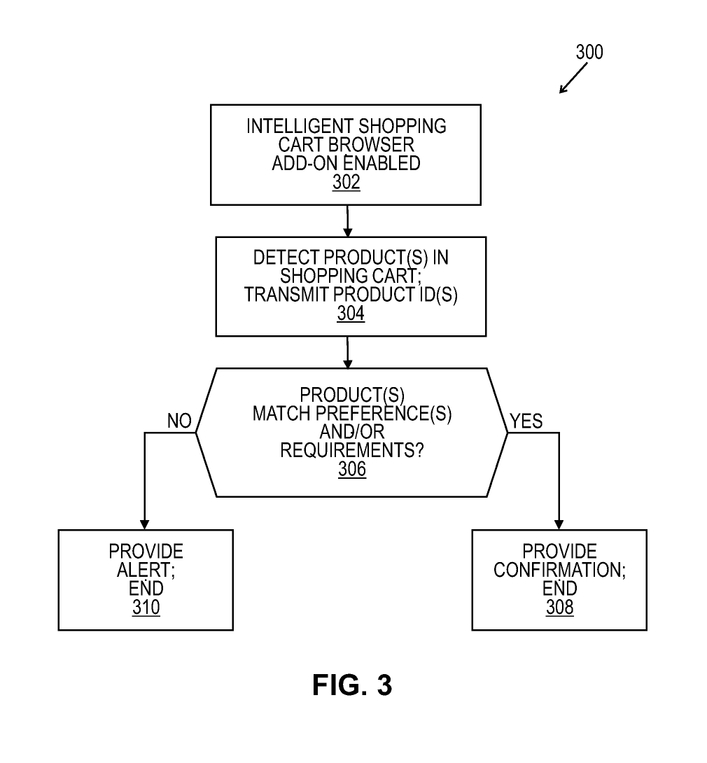

FIG. 3 is a flowchart illustrating an online intelligent shopping cart process 300 according to an embodiment. The consumer enables 302 intelligent shopping cart add-on software in his or her Internet browser, which may have been downloaded from the intelligent shopping cart server computer 102 to the consumer's device (such as to a personal computer or to a laptop computer running browser software such as Internet Explorer® or Google Chrome®). The intelligent shopping cart add-on software detects 304 that the consumer has placed or added products to a virtual shopping cart (for example, when the consumer is shopping at a merchant website). In some embodiments, the intelligent shopping cart add-on software transmits a product identifier for each product or service that was placed in the virtual shopping cart to the intelligent shopping cart server computer 102. The product or service is then identified and compared to the predetermined preferences, criteria and/or requirements provided by the consumer during registration, and which are stored in the preferences database 106. In step 306, if the intelligent shopping cart server computer 102 determines that a product in the virtual shopping cart matches the consumer's preferences and/or requirements, then a confirmation message is transmitted by the intelligent shopping cart server computer to the consumer's device so as to provide 308 a confirmation (which, for example, may be a visual indication and/or an audible indication). For example, when a product placed in the virtual shopping cart matches the consumer's preferences then a green checkmark may appear next to that product's description in the virtual shopping cart to confirm alignment with the consumer's preferences, criteria and/or requirements. However, in some implementations, the intelligent shopping cart add-on software may be configured such that no notification or indication is provided when a product or service matches the consumer's preferences, criteria and/or requirements because, for example, the consumer may not want or need such an assurance.

Referring again to FIG. 3, if in step 306 the intelligent shopping cart server computer determines that a product in the virtual shopping cart is a mismatch with regard to the consumer's preferences, criteria or requirements, then an alert notification or alert message is transmitted by the intelligent shopping cart server computer to the consumer's device so as to provide 310 an alert. This alert notification is provided before the purchase transaction is consummated to give the consumer an opportunity to consider whether to continue with the purchase or to replace that item with another item. For example, a red icon (such as a red octagon-shape icon or a red “X” icon) may appear next to the product description. In addition, a link to further information may be provided that explains why that product is not aligned with the consumer's preferences. Other types of notifications may also be used or included, such as an audible notification (i.e. a sound or a short message indicating a mismatch), or a pop-up text box that contains an advisement message with further details and/or options. The consumer may then replace any mismatched or misaligned products in the cart before consummating the purchase transaction with a different product that meets his or her criteria, which saves time and avoids a potential product return scenario.

In addition, when a mismatch is detected, in some implementations the intelligent shopping cart software may be configured to provide suggested replacement product(s) or service(s) to a consumer, which may be based on information provided by the consumer and/or based on data obtained from one or more merchants regarding the types of products in that merchant's inventory. For example, the merchant may have provided a list of products that are similar in some regards, but have one or more different characteristics, but that still may align or substantially align with some (or a majority) of the consumer's preferences. In some implementations, the suggested replacement products or services may be associated with a different, second merchant than the current merchant, in which case one or more universal resource locater (URLs) or links may be provided for the consumer to open a new webpage and so that the consumer can easily navigate to the second merchant's website to purchase a replacement item. Yet further, in some embodiments, when a mismatch is identified and the consumer is notified, the intelligent shopping cart software may be further configured to prevent consummation of the purchase transaction until the consumer verifies and/or clears each alert notification. For example, the consumer may be required to respond to an advisement dialogue box which may present the following message: “At least one item in your shopping cart does not match your preferences. Do you still wish to continue with your purchase? Yes/No”. The consumer would then be required to check a “Yes” radio button (for example) before proceeding with checkout, or a “No” radio button to return to the item list and determine whether or not to delete or replace one or more items that have been flagged as being misaligned with the consumer's preferences, criteria and/or requirements. It should be understood that other types of messages and/or data input procedures could be used to communicate with and receive input from the consumer in such manner.

In the case where a particular product and/or service that has been added to the virtual shopping cart cannot be identified, and thus cannot be compared to the consumer's preferences, criteria and/or requirements, then an indication may be provided to the consumer advising him or her of this fact. For example, a yellow icon indicator may be provided near the description of such an item for display to the consumer that resembles a “caution” sign or icon. In this case, the consumer may also be prompted to login to his or her intelligent shopping cart account and provide further information concerning that product or service, including any preferences, criteria and/or requirements to associate with it. In some implementations, the mere fact that one or more items have been flagged in this manner does not prevent the consumer from consummating the purchase transaction.

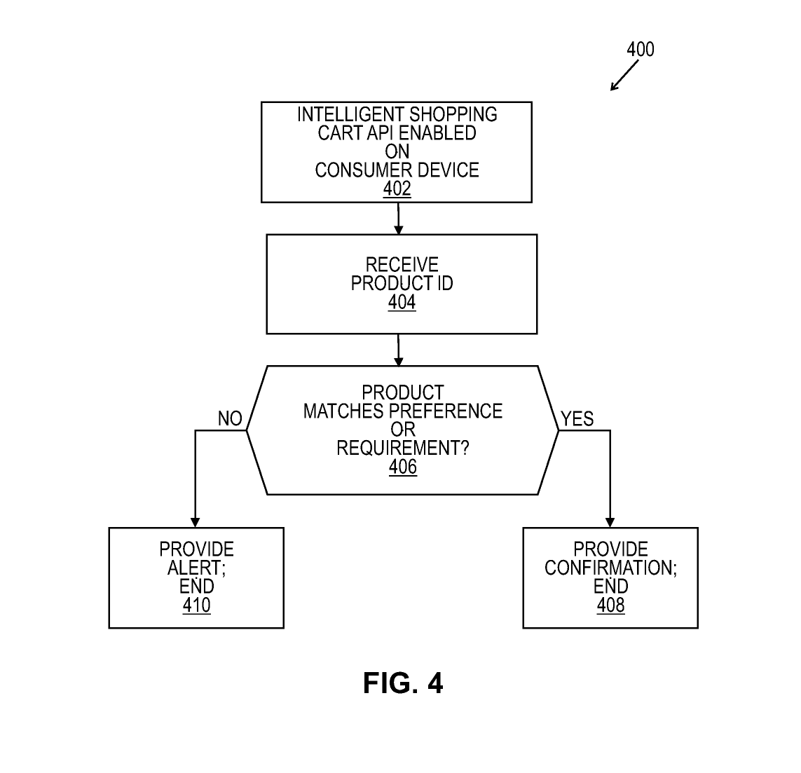

FIG. 4 is a flowchart illustrating a consumer mobile device intelligent shopping cart process 400 according to an embodiment. In a scenario, a consumer who has already registered for the intelligent shopping cart service enters a merchant location, such as a retail store, with his or her consumer mobile device (which may be, for example, a tablet computer or Smartphone). The consumer mobile device includes an intelligent shopping cart API program enabled 402 thereon, and the consumer begins shopping. Before placing selected merchandise into a physical shopping cart, the consumer scans the product ID (such as a barcode label containing the product SKU) which is received 404 by the intelligent shopping cart application. The API uses the product ID to determine 406 whether or not the product matches that consumer's preferences, criteria or requirements data. In particular, in some embodiments the API may compare the scanned product ID to product IDs stored in a memory (such as a memory of the consumer's mobile phone) and if there is a match, then the API provides 408 a confirmation indication. In some implementations, if there is no product ID match, the API may then compare characteristics and/or attributes of the product associated with the scanned product ID (which may be stored in a database) to the consumer's preferences stored in a memory (which may be a memory of the consumer's mobile device or may be a remote database), and if the API determines that the product characteristics and/or attributes match the consumer's preferences then the API provides 408 a confirmation indication. But if the scanned product ID does not match a stored product ID and the characteristics and/or attributes of the scanned product do not match the consumer's preferences, then the API provides 410 an alert notification.

In some embodiments, in order to determine whether or not products chosen by the consumer match or do not match the consumer's preferences, the API transmits the product ID for each product to the intelligent shopping cart server computer 102. The intelligent shopping cart server computer 102 identifies the consumer by data contained in an intelligent shopping cart product ID request generated by the consumer's Smartphone, then identifies and compares the product ID to the preferences, criteria and/or requirements associated with that consumer, which are stored in the preferences database 106. When the intelligent shopping cart server computer determines that the product ID matches the consumer's preferences then, in some embodiments, a confirmation message is transmitted by the intelligent shopping cart server computer to the API for display on the consumer's mobile device. As explained above, in other implementations, no confirmation message is provided. If the intelligent shopping cart server computer instead determines that a product is a mismatch with regard to the consumer's preferences or requirements, then an alert message is transmitted to the API, which may then cause an audible notification and/or a visual notification to be provided to the consumer by the consumer's mobile device.

In some embodiments, when a product matches the consumer's preferences then a green checkmark or other type of icon may appear next to that product's description on a display screen of the consumer's mobile device. But if there is a mismatch, then a red mismatch icon (for example, a red “stop sign” icon) or other type of indication may instead appear next to the product description to alert the consumer before a purchase transaction is consummated. As explained above, other types of notifications or alerts may also be used or included, such as an audible notification, or a text message transmitted to the consumer's device that contains further details (especially in the case of a product or item mismatch or potential mismatch). When the consumer is shopping online, such notifications and/or indications may take the form of icons or marks on an online shopping itemized receipt that is generated by the online merchant in an online shopping cart, which is presented for review to the consumer before the purchase is consummated. In addition, in a retail store environment, when a merchant device such as a point-of-sale (POS) terminal (for example, a cash register) includes intelligent shopping cart software or is integrated with the intelligent shopping cart system through, for example, wireless communication, then a printed receipt (being prepared by the a merchant device for the consumer) may include one or more types of indications regarding mismatched items or services. For example, as items are being scanned by a cashier at a POS terminal located at the retail store checkout line, the POS terminal may indicate mismatched items in red on a display screen visible to the consumer and/or may provide an audio indication (such as a loud tone) when a mismatched item is scanned so that the consumer may be provided with an opportunity to decline that item or product and/or replace it with different merchandise that aligns with his or her preferences and/or requirements. A printed receipt may also be presented to the consumer that includes marks and/or icons indicating mismatched items, which may be indicated by, for example, different colors and/or shapes or fonts.

In any of the example scenarios outlined above, the consumer may have the opportunity to replace any mismatched or misaligned products in his or her shopping cart with different merchandise (or service) that meets his or her criteria, which saves time and avoids a potential product return scenario (or disappointment with regard to a service). Furthermore, in some embodiments, the intelligent shopping cart software may be configured to provide one or more suggested replacement products when a mismatch is detected. Any replacement suggestions or proposals may be based on preference and/or requirements information provided by the consumer and/or may be based on merchant data, for example, merchant data indicating products that are available in store inventory. In some embodiments, the replacement product or service suggestions may include an electronic link to a replacement product on the merchant's website and/or a product description and/or a product name and location of that product in that merchant's retail store. In some implementations, the suggested or proposed replacement item or service may be associated with a different merchant than the current merchant.

In some embodiments, when a registered consumer of the intelligent shopping cart service enters a merchant location (such as a retail store) with his or her consumer mobile device, the intelligent shopping cart API program enabled thereon is configured to determine or recognize when the consumer enters or is in a merchant retail location. For example, the consumer's mobile device may include global positioning service (GPS) enabled circuitry that provides location coordinates that can be matched to one or more merchants' retail locations (in some implementations, only for those merchants participating in the intelligent shopping cart service). Once the intelligent shopping cart API program determines that the consumer is in a retail location, it may next be configured to conduct a search to determine if the consumer prepared an intelligent shopping cart list (or a shopping list of items the consumer desires to purchase). If so, then the intelligent shopping cart API may communicate with the intelligent shopping cart server to obtain a retail store map that includes the layout of that particular retail store and/or the location of each item on the intelligent shopping cart list. In addition, the intelligent shopping cart server may be configured to provide an optimal path (or shopping directions) for the consumer to walk to pick up each item on the intelligent shopping cart list. For example, in an implementation, the intelligent shopping cart server computer searches a retail store map database that contains merchant retail store information including store layout data (such as a map of each selling floor), retail store product location data, and the like. The intelligent shopping cart server computer may then download the shopping directions to the consumer's mobile device (or to a merchant device provided in the retail store for use by consumers) for display to the consumer, for example, on a touch screen. In some implementations, the intelligent shopping cart API program may access memory in the consumer's mobile device that has been preloaded with one or more merchant retail store maps and/or product locations. Such mapping data may be compiled over time as the consumer shops at various merchant stores and stored in the memory of the consumer's mobile device, so that retrieval of such mapping data is optimized for quick display to the consumer while shopping at merchant retail store locations that are typically frequented by the consumer. The intelligent shopping cart API may be configured to periodically update such mapping data on various consumer devices as merchants report changes to store layout data and/or product placement in their retail stores.

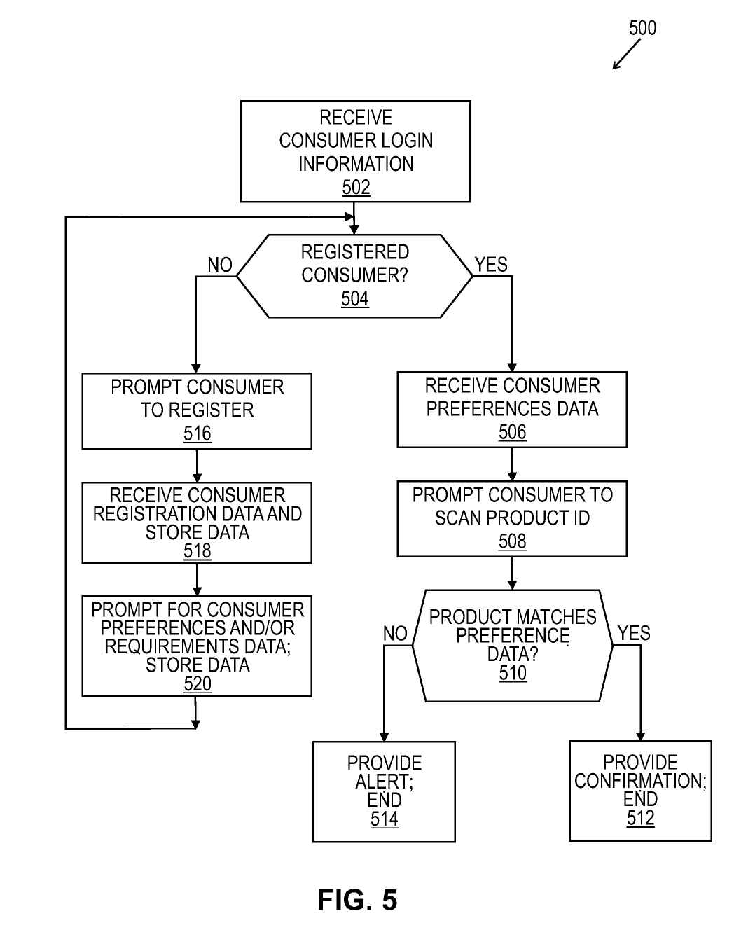

FIG. 5 is a flowchart illustrating a merchant device intelligent shopping cart process 500 according to an embodiment. A consumer who has already registered for the intelligent shopping cart service enters a merchant location, such as a retail store, and obtains a physical shopping cart having an attached merchant device (or picks up such a merchant device, for example, from an in-store customer courtesy desk). The merchant device may be attached to the shopping cart via a cable or be otherwise affixed thereto, and may be in the form of a tablet computer (or equivalent) having a touchscreen (or other input device) and an associated reader device. In some implementations, the merchant device may be a dedicated shopping device or custom-made electronic device that is only configure for use inside the merchant's retail store in order to reduce the risk of theft. In some embodiments, the merchant device is configured for wireless communications via a router with an in-store computer server, for example, via a WiFi network connection. The consumer utilizes the touch screen on the merchant device to initialize the intelligent shopping cart service by, for example, pressing an appropriate icon and then providing his or her consumer ID information (username and passcode) to login to the system. In some embodiments, instead of providing consumer ID information, the consumer may be able to swipe his or her magnetic stripe payment card, or tap his or her proximity payment device, or utilize a merchant loyalty card in an appropriate manner utilizing a reader component associated with the merchant device to gain access to the intelligent shopping cart service.

Referring again to FIG. 5, the merchant device determines 504 whether or not the customer is a registered consumer. This may involve transmitting the consumer ID and/or other customer data via the WiFi network to the intelligent shopping cart server computer 102 for verification, or may involve locally verifying the consumer (for example, if the customer is a frequent customer of that merchant's retail store, then a database entry may be locally stored that can be checked to confirm registration of that consumer). If a determination is made that the customer is enrolled with the intelligent shopping cart service, then the merchant device receives 506 (or retrieves from a database) consumer preferences and/or requirements data associated with that consumer. The merchant device then prompts 508 the consumer to scan product IDs using the associated scanning device (which may be a barcode wand reader) as items are selected from store shelves or display racks and placed into the physical shopping cart. For example, the consumer scans product ID barcodes (which may contain the product SKU) of various food items, and then the intelligent shopping cart software uses the product ID to determine whether or not a particular food product matches that consumer's preferences and/or requirements data. If the food product matches the consumer's preferences (for example, items are sugar-free and/or gluten-free) then the merchant device provides 512 a confirmation indication, but if the product does not match then the merchant device provides 514 an alert notification.

In an implementation, when a determination is made that the product ID matches the consumer's preferences and/or requirements then the merchant device emits a confirmation tone that is audible to the consumer, and/or a confirmation icon or message is displayed on the touch screen. However, if a determination is made that a product is a mismatch with regard to the consumer's preferences, criteria or requirements, then an alert tone, which may be louder and/or more forceful than the confirmation tone, is emitted from the merchant device, and/or an alert or warning message is displayed on the touch screen. Other types of notifications may also be used or included, such a text message that includes details, for example, explaining why a particular food product is a mismatch item. The consumer then has the opportunity to remove and/or replace any mismatched or misaligned products in the shopping cart with a different product that meets his or her criteria, which saves time and avoids a potential product return scenario. Furthermore, in some embodiments, the merchant device may be configured to provide one or more suggested replacement products when a mismatch is detected, which suggestion(s) may be based on information provided by the consumer and/or by the merchant (which may be based at least partially on merchant retail store inventory data).

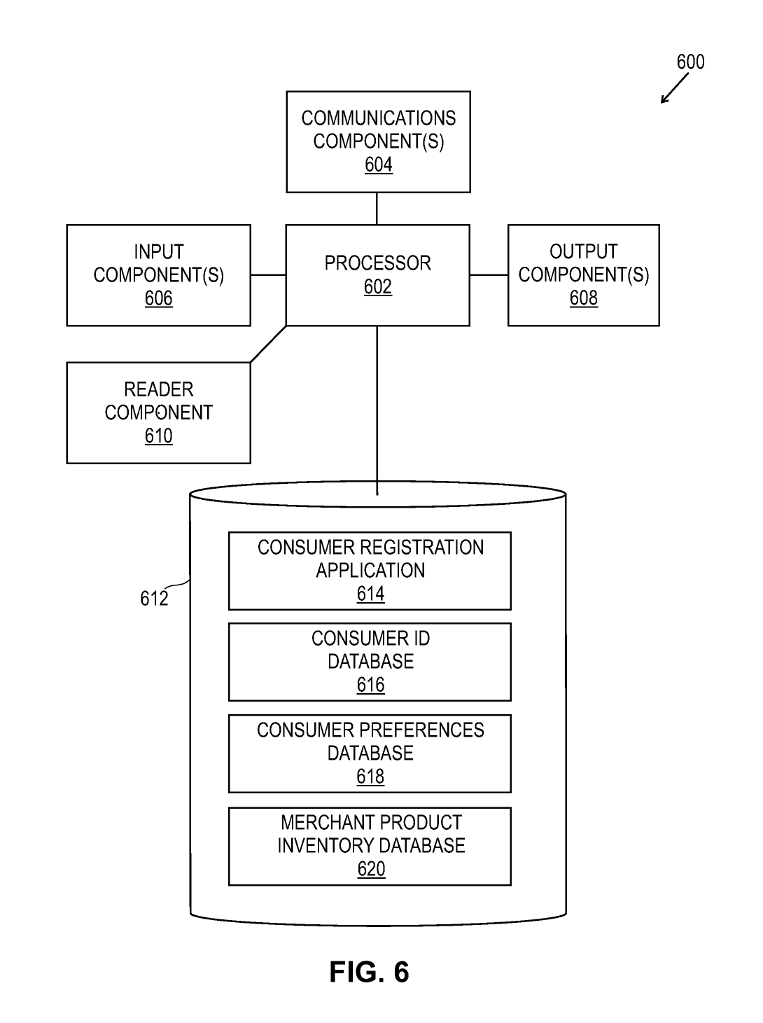

FIG. 6 is a block diagram illustrating an intelligent shopping cart merchant device 600 configured to provide intelligent shopping cart service functionality according to an embodiment. A computer processor 602 is operatively coupled to communication component(s) 604, input component(s) 606, output component(s) 608, a reader component 610, and a storage device 612.

The computer processor 602 may be constituted by one or more conventional processors. Processor 602 operates to execute processor-executable steps, contained in program instructions described below, so as to control the intelligent shopping cart merchant device 600 to provide desired functionality.

Communication component(s) 604 may be used to facilitate communication with, for example, other devices (such as merchant server computers and or wireless routers connected to the internet (not shown)). Communication component(s) 604 may, for example, have capabilities for sending and receiving messages over WiFi networks, via the Internet, and/or engaging in data communication over conventional computer-to-computer data networks.

Input component(s) 606 may comprise one or more of any type of peripheral device typically used to input data into a computer. For example, the input device 606 may include a keyboard and/or a mouse or may be a touchscreen. Output component(s) 608 may comprise, for example, a touchscreen display and/or an audio speaker or some other device. The reader component 610 may be configured to read product ID labels (such as barcode labels) and/or other products and/or services identification indicia during operation of the intelligent shopping cart merchant device 600.

Storage device 612 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as flash memory. Thus, the storage device 612 is a non-transitory computer readable medium and/or any form of computer readable media capable of storing computer instructions and/or application programs and/or data. It should be understood that non-transitory computer-readable media comprise all computer-readable media, with the sole exception being a transitory, propagating signal.

Storage device 612 stores one or more programs or applications for controlling the processor 602. The programs comprise program instructions that contain processor-executable process steps of the intelligent shopping cart merchant device 600, including, in some cases, process steps that constitute processes provided in accordance with principles of the present invention, as described in more detail below.

The programs stored by the storage device may include a consumer registration application 614 that manages a process by which consumers or customers (which may be payment card account holders or cardholders) may register or enroll themselves and/or their electronic devices by utilizing the intelligent shopping cart merchant device 600. In some embodiments, the consumer enrollment process may allow the consumer to enroll by accessing a suitable web page hosted by the intelligent shopping cart server computer 102 (see FIG. 1). The information obtained from the consumer during the enrollment process includes product and/or service preferences and/or requirements data and/or other information (which may include information concerning the consumer's payment card accounts). The enrollment process may also require the consumer to select a username and password or PIN (personal identification number) to be used for security purposes, and/or for use by a consumer to login and change one or more preference and/or requirement settings, for example. Other security measures may also be put in place, including industry-standard cardholder security processes and/or procedures.

The storage device 612 may store one or more databases, such as a consumer identification database 616, a consumer preferences database 618, and a merchant product inventory database 620. The merchant device 600 may be operable to obtain data to populate such databases from sources such as the intelligent shopping cart server computer 102 and/or from one or more merchant server computers.

The application programs of the smart preferences computer 600 may be combined in some embodiments, as convenient, into one, two or more application programs. Moreover, the storage device 610 may store other programs, such as one or more operating systems, device drivers, database management software, web hosting software, and the like.

In some embodiments, derived intelligence data may be utilized to provide replacement product and/or service suggestions when a mismatch occurs between a consumer's predetermined product or service preferences, criteria or requirements and the selected products and/or services for purchase. In particular, data concerning products or services found at social media websites such as Facebook® and/or Twitter® may be analyzed or monitored to provide recommendations. For example, when a customer preference is to purchase clothing that conforms to current fashion trends, a selected garment may not be appropriate and thus be a mismatch. The intelligent shopping cart computer server 102 may then utilize data obtained from Twitter® to determine what garments are currently fashionable, and to generate one or more replacement products or services suggestion(s) to recommend. The derived intelligence data may include the merchant name and/or merchant category, the merchant location, the gender of the consumer, and/or the segment to which the consumer or cardholder belongs (for example, the cardholder may have been categorized, for example, as belonging to one or more segments characterized as being affluent, mass market, urban, youth, early adopter, and the like). Each time a consumer utilizes the intelligent shopping cart system, data about his or her purchase transactions may be stored in an intelligent shopping cart log (in a database, for example). For example, a merchant device and/or a consumer's handheld device running the intelligent shopping cart software may transmit purchase transaction item details to the intelligent shopping car log when a purchase transaction is consummated. Thus, the intelligent shopping cart log may include data concerning transaction data such as the merchant name and location, the amount of the purchase, the date and time of the transaction, the merchant category, whether or not it was a cross border transaction, the card holder location, the currency used and/or interchange rate, any recommended replacement product(s), the selection made by the consumer (whether or not a recommendation was followed), and the cardholder segment.

The intelligent shopping cart server computer may be configured to periodically access the intelligent shopping cart log to identify purchase transaction data associated with one or more consumers. Based on the purchase transaction data, the intelligent shopping cart server computer may operate to modify one or more weightings associated with one or more consumer preferences, criteria or requirements that are stored in the preferences database. Such operation can improve, for example, the efficacy of subsequent recommendations for replacement products or services. Thus, the intelligent shopping cart replacement product recommendation process may include self-learning, which occurs by analyzing historical purchase transaction data of consumers and/or cardholders, historic replacement product recommendations with relation to the actual selections made by consumers, and aggregated intelligence data (for example, by analyzing purchase transaction data of consumers of a particular segment). For example, the self-learning process may result in recognizing a trend or an affinity regarding selection of a particular type of product or service under certain circumstances that is detected by the intelligent shopping cart computer system, and which can be utilized to result in making better and quicker future product and or service recommendations for cardholders.

In some embodiments, Issuer FIs or issuer banks and/or Acquirer FIs and/or merchant banks can also register with the intelligent shopping cart system. Each of these entities may provide benefits information and/or rewards information (which may be stored in a benefits database) and one or more rules and/or limitations concerning one or more of the payment card accounts and/or restrictions or limitations on rewards and/or benefits offered to consumers. Information can include, but not be limited to, the amount of points or cash back rewards that can be earned for purchasing certain types of goods or services, and/or for purchasing a certain dollar amount of goods or services from particular merchants, the expiration date(s) for obtaining particular rewards or benefits, and/or rules that may govern obtaining certain rewards or benefits such as limits on the total amount of rewards that can be obtained. In this manner, consumers can earn standard benefits that are offered by payment card account entities such as MasterCard®, VISA® and American Express®, can earn additional issuer benefits or rewards (typically added-on benefits provided by Issuer FIs such as banks), and/or can earn merchant benefits (for example, exclusive benefits offered by a particular merchant, such as a low price-match guarantee, or loyalty points). In some embodiments, the benefits information and/or rewards information may be stored in one or more databases and may be provided to consumer when a replacement product or service is recommended. Furthermore, based in product or service selections and/or replacement product or service recommendations, the intelligent preference service computer may be configured to also make electronic wallet recommendations involving one or more consumer payment accounts. For example, if a replacement product is recommended that is associated with “BigBox Electronics Store” then the intelligent preferences service computer may recommend that the consumer purchase that replacement product with the consumer's BigBox Electronics Store MasterCard® Rewards credit card. Such functionality may require the intelligent preference service computer to communicate with one or more databases that include consumer electronic wallet data, for example.

In some embodiments, consumers may enroll and utilize the intelligent shopping cart service at no cost, as one or more entities (such as merchants, issuer banks, payment card processing companies, and the like) may subsidize such a service. Thus, consumers who utilize the intelligent shopping cart service are happy because they save time (and possibly money) by purchasing only those products and services that match their preferences. The merchant is also happy to sell products that consumers appreciate and will not return, possibly earning loyal customers in the process. In addition, a third party intelligent shopping cart service provider, such as MasterCard International Incorporated, is happy to power a beneficial shopping experience for consumers (and possibly obtain new cardholders and/or merchant issuer financial institution customers due to the service).

The flow charts and descriptions thereof herein should not be understood to prescribe a fixed order of performing the method steps described therein. Rather the method steps may be performed in any order that is practicable.

As used herein and in the appended claims, the term “payment card account” includes a credit card account or a deposit account that the account holder may access using a debit card or a gift card account. The term “payment card account number” includes a number that identifies a payment card account or a number carried by a payment card, or a number that is used to identify an account in a payment system that handles debit card and/or credit card transactions or to route a transaction in a payment system that handles debit card and/or credit card transactions. The term “payment card” includes a credit card or a debit card (including a pre-paid debit card) or a gift card. The term “payment card account” also includes an account to which a payment card account number is assigned. Thus a payment card account may include an account to which payment transactions may be routed by a payment system that handles debit card and/or credit card and/or gift card transactions, even if the account in question is not eligible to be charged for purchase transactions or other transactions. A payment card account may also include an account from which payment transactions may be routed by a payment system that handles debit card and/or credit card and/or gift card transactions, even if the account in question is not customarily used, or is not eligible, to be charged for purchase transactions.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method comprising:
storing, by a processor in a memory, intelligent shopping cart software;
detecting, by the processor running the intelligent shopping cart software, product or service identification data when a consumer adds a product or service to a shopping cart;
determining, based on the product or service identification data, that the product or service is a mismatch with at least one of predetermined consumer preferences data, criteria data or requirements data; and
providing, by the processor via an output component, an alert indication before a purchase transaction is consummated.

2. The method of claim 1, further comprising providing, by the processor via the output component, an indication of at least one replacement product or service.

3. The method of claim 2, wherein providing an indication comprises at least one of providing at least one universal resource indicator (URL) associated with a replacement product or service and providing a description of at least one replacement product or service associated with a merchant.

4. The method of claim 2, wherein providing the indication of replacement products or services comprises:
deriving intelligence data from at least one social media website; and
generating, based on the derived intelligence data, at least one product or service suggestion for presentation via the output component to the consumer.

5. The method of claim 1, further comprising:
providing, by the processor via the output component, an advisement notification to the consumer before the purchase transaction is consummated; and
permitting the consumer to proceed with a checkout procedure after receiving a confirmation indicating that the consumer desires to proceed.

6. The method of claim 1, wherein determining that the product or service is a mismatch comprises:
transmitting, by the processor to an intelligent shopping cart computer, the product or service identification data for comparison to the predetermined consumer preferences, criteria or requirements stored in a preferences database; and
receiving, by the processor from the intelligent shopping cart computer, an indication of a mismatch.

7. The method of claim 1, further comprising, prior to detecting the product or service identification data:
detecting, by the processor, that the consumer entered a merchant location;
identifying, by the processor, an intelligent shopping cart list prepared by the consumer;
providing, by the processor on via an output component, a merchant location map to the consumer that includes the location of each item on the intelligent shopping cart list.

8. The method of claim 7, further comprising providing, by the processor via the output component, an optimal path to the consumer for locating each item on the intelligent shopping cart list.

9. The method of claim 1, further comprising transmitting, by the processor to an intelligent shopping cart computer, purchase transaction item details when a purchase transaction is consummated.

10. The method of claim 9, further comprising storing, by the intelligent shopping cart computer, the purchase transaction details in an intelligent shopping cart log.

11. The method of claim 10, further comprising:
accessing, by an intelligent shopping cart server computer, the intelligent shopping cart log;
identifying, by the intelligent shopping cart server computer, purchase transaction data associated with one or more consumers; and
modifying, by the intelligent shopping cart server computer, one or more weightings associated with one or more consumer preferences, criteria or requirements stored in a preferences database based on the purchase transaction data.

12. The method of claim 1, wherein the intelligent shopping cart software comprises an application programming interface (API).

13. The method of claim 1, further comprising, before determining a product or service mismatch:
determining that a product or service identification data cannot be identified; and
providing, by the processor via an output component, an unidentified product or service notification to the consumer.

14. An apparatus, comprising:
a processor;
a reader component operably connected to the processor and configured for reading products and services identification indicia;
an output component operably connected to the processor; and
a non-transitory storage device operably connected to the processor, the storage device storing processor executable program instructions configured to instruct the processor to:
store intelligent shopping cart software;
receive, from the reader component, products or services identification indicia data when a consumer adds a product or service to a shopping cart;
determine, based on the product or service identification indicia data, that the product or service is a mismatch with predetermined consumer preferences, criteria or requirements data; and
transmit instructions configured to provide an alert indication via the output component for the consumer before a purchase transaction is consummated.

15. The apparatus of claim 14, wherein the program instructions stored in the non-transitory storage device further comprises instructions configured to instruct the processor to provide an indication of replacement products or services.

16. The apparatus of claim 14, wherein the program instructions stored in the non-transitory storage device further comprises, prior to the instructions for detecting the product or service identification data, instructions configured to instruct the processor to:
detect when a consumer enters a merchant location;
identify an intelligent shopping cart list prepared by the consumer; and
provide a merchant location map via the output component to the consumer that includes the location of items on the intelligent shopping cart list.

17. The apparatus of claim 14, wherein the program instructions stored in the non-transitory storage device further comprises instructions configured to instruct the processor to provide an optimal path map via the output component to the consumer for locating each item on the intelligent shopping cart list.

18. The apparatus of claim 14, wherein the program instructions stored in the non-transitory storage device further comprises instructions configure to instruct the processor to:
derive intelligence data from at least one social media website;
generate, based on the derived intelligence data, at least one product or service suggestion; and
transmit instructions to the output component to provide the at least one product or service suggestion to the consumer.

19. The apparatus of claim 14, further comprising an input component operably connected to the processor, and wherein the program instructions stored in the non-transitory storage device further comprises instructions configure to instruct the processor to:
provide an advisement notification via the output component to the consumer before the purchase transaction can be consummated;
receive an indication via the input component indicating that the consumer desires to proceed with the purchase transaction; and
transmit instructions to the output component to provide a checkout procedure to the consumer.

20. The apparatus of claim 14, wherein the program instructions stored in the non-transitory storage device further comprises instructions configure to instruct the processor to transmit purchase transaction item detail data to an intelligent shopping cart computer when a purchase transaction is consummated.

21. The apparatus of claim 14, wherein the output component comprises at least one of an audio device and a display device, and wherein the program instructions stored in the non-transitory storage device further comprises instructions configured to instruct the processor to provide at least one of an audio alert notification and a visual alert notification.

22. A non-transitory computer readable medium storing instructions configured to cause a processor to:
store intelligent shopping cart software;
receive products or services identification indicia data when a product or service is added to a shopping cart;
determine that the product or service identification indicia data is a mismatch with at least one of predetermined consumer preferences data, criteria data or requirements data; and
transmit instructions to at least one of an audio output component and a visual output component to provide an alert indication for the consumer before a purchase transaction is consummated.

23. The non-transitory computer readable medium of claim 22, further comprising instructions configured to instruct the processor to transmit instructions to at least one of the audio output component and the visual output component to provide an indication of replacement products or services for the consumer.

24. The non-transitory computer readable medium of claim 22, further comprising instructions, prior to the instructions for detecting the product or service identification data, configured to instruct the processor to:
detect when a consumer enters a merchant location;
identify an intelligent shopping cart list prepared by the consumer; and
provide a merchant location map via the output component to the consumer that includes the location of items on the intelligent shopping cart list.

25. The non-transitory computer readable medium of claim 24, further comprising instructions configured to instruct the processor to provide an optimal path map via the output component to the consumer for locating each item on the intelligent shopping cart list.

26. The non-transitory computer readable medium of claim 22, further comprising instructions configured to instruct the processor to:
derive intelligence data from at least one social media website;
generate, based on the derived intelligence data, at least one product or service suggestion; and
transmit instructions to at least one of the audio output component and the visual output component to provide at least one product or service suggestion to the consumer.

27. The non-transitory computer readable medium of claim 22, further comprising instructions configured to cause the processor to:
transmit instructions to at least one of the audio output component and the visual output component to provide an advisement notification to the consumer before the purchase transaction can be consummated;
receive input data indicating that the consumer desires to proceed with the purchase transaction; and
transmit instructions to the visual output component to provide a checkout procedure to the consumer.

28. The non-transitory computer readable medium of claim 22, further comprising instructions, prior to the instructions for determining a product or service mismatch, configured to cause the processor to:
determine that the products or services identification indicia data cannot be identified; and
transmit instructions to at least one of the audio output component and the visual output component to provide an unidentified product or service notification to the consumer before a purchase transaction is consummated.
